(19) United States
(12) Patent Application Publication
(10) Pub. No.: US 2019/0060901 A1
(43) Pub. Date: Feb. 28, 2019

(54) DEVICE AND METHOD FOR REFINING PARTICLES

(71) Applicant: Oslofjord Ressurspark AS, Borre (NO)

(72) Inventors: Nhut TRAN-MINH, Borre (NO); Frank KARLSEN, Borre (NO)

(21) Appl. No.: 16/081,587

(22) PCT Filed: Mar. 6, 2017
(86) PCT No.: PCT/EP2017/055221

§ 371 Date: Aug. 31, 2018

(30) Foreign Application Priority Data
Mar. 4, 2016 (GB) 1603819.2

(51) Int. Cl. B01L 3/00

(52) U.S. Cl. CPC B01L 3/502761; B01L 3/502753; B01L 2200/0652; B01L 2400/086; B01L 2300/0816; B01L 2300/0851; B01L 2300/087; B01L 2300/0681

(57) ABSTRACT

Disclosed herein is a device for the continuous refining of particles of differing properties, the device comprising: a combination of upstream and downstream separation and concentration systems, each of the upstream and downstream separation and concentration systems comprising: a plate having opposing first and second sides, each of first and second sides having disposed thereon or therein first and second channels, respectively, the first and second channels being fluidly connected to one another by a plurality of apertures through the plate that allow fluid flow from the first to the second channel, and a plurality of pillars are disposed on the first side of the plate adjacent each aperture to prevent particles above a certain size passing through the aperture, the fluid flow direction along first and second channels during separation being approximately the same, and the plate has an outlet from the first channel downstream from the plurality of apertures on the first side of the plate, wherein the upstream separation system has an outlet from the second channel that is fluidly linked to the inlet of the first channel of the downstream separation system, and the separation distance between adjacent pillars on the first side of the plate in the upstream system is more than the separation distance between adjacent pillars on the first side of the plate in the downstream system.

### FIELD OF THE INVENTION

The present invention relates to a refining device that can be used to treat complex mixtures, to prepare them for subsequent use or analysis. The refining device can be used, for example, to separate components of complex mixture and/or homogenize and mix the components of the fluid with other substances as desired. It may be used, for example, to separate and concentrate particles at the macro- or micron- or nanoscale.

### BACKGROUND

Many fields, such as microfluidics, require the processing and analysis of complex mixtures. Some microfluidic techniques involve the filtration of particle-containing fluids, to try to separate particles on the basis of their differing properties. Many different techniques have been developed for particle separation, which may be categorized into passive and active. Passive techniques use the interaction between particles, flow and channel structures to effect separation, but do not need the application of an external field. Active techniques use external fields, e.g. non-uniform electrical fields or magnetic fields, to separate particles.

Passive techniques typically involve different arrangements of channels and features within them, which effect separation of particles, typically on the basis of size. Techniques include pinched flow fractionation, intertia and dean flow fractionation, microvortex manipulation, deterministic lateral displacement, techniques based on the Zweifach-Fung effect, filtration techniques using membranes, pillars and/or weirs, hydrodynamic filtration and micro-hydrocyclones. Further detail of these techniques can be found in literature, one example of which is a review article: Particle separation and sorting in microfluidic devices: a review (Microfluid Nanofluid (2014) 17:1-52). Filtration techniques using membranes and rows of pillars suffer from the similar problem of filter fouling. Particles become trapped in the membrane or between the pillars and this reduces the separation efficiency.

There is a challenge when producing microfluidic separation devices for very small-scale, particularly with small structures, such as pillars of the micron or nano-scale. Any production technique should allow for the units to be produced efficiently, and consistently. The present inventors have found that this can be particularly difficult with filtration units that have different layers—the layers have been found to move out of alignment during production and/or in use, which can lead to failure of the devices.

The difficulties encountered at the microfluidic scale can also be encountered at the macroscale, and the macroscale separation of particles can have its own difficulties.

There is a desire to produce an alternative to the prior art separation devices that can be produced efficiently and consistently, and, ideally, avoid the filter fouling problems associated with some of the prior art, and be used at either the macro-scale or micron-scale or below.

### SUMMARY OF THE INVENTION

In a first aspect, the present invention provides a device for the continuous refining of particles of differing properties, the device comprising:
a combination of upstream and downstream separation and concentration systems, each of the upstream and downstream separation and concentration systems comprising:
a plate having opposing first and second sides, each of first and second sides having disposed thereon or therein first and second channels, respectively, the first and second channels being fluidly connected to one another by a plurality of apertures through the plate that allow fluid flow from the first to the second channel, and
a plurality of pillars are disposed on the first side of the plate adjacent each aperture to prevent particles above a certain size passing through the aperture, the fluid flow direction along first and second channels during separation being approximately the same,
and the plate has an outlet from the first channel downstream from the plurality of apertures on the first side of the plate,
wherein the upstream separation system has an outlet from the second channel that is fluidly linked to the inlet of the first channel of the downstream separation system, and
the separation distance between adjacent pillars on the first side of the plate in the upstream system is more than the separation distance between adjacent pillars on the first side of the plate in the downstream system.

In a second aspect, the present invention provides a method for the continuous separation and concentration of particles of differing properties, the method comprising:
providing a device according to the first aspect
inputting a fluid comprising a mixture of particles of varying properties into the first channel of the upstream separation system, such that the fluid flows along the first channel to the plurality of apertures, with some of the fluid (a first portion) passing along the outlet of the first channel, and some of the fluid (a second portion) passing through the apertures into the second channel and through the output of the second channel of the upstream separation system to the input of the first channel of the downstream separation system,
the second portion of the fluid passing along the first channel of the downstream separation system to the plurality of apertures, with some of the fluid (a third portion) passing along the outlet of the first channel and some of the fluid (a fourth portion) passing through the apertures into the second channel and through the output of the second channel of the downstream separation system,
wherein, optionally, the first portion of fluid has a higher concentration of larger particles than the fourth portion of fluid.

In a third aspect, the present invention provides a separation and concentration system comprising:
a plate having opposing first and second sides, each of first and second sides having formed therein first and second channels, respectively, the first and second channels being fluidly connected to one another by a plurality of apertures through the plate that allow fluid flow from the first to the second channel, and
a plurality of pillars are disposed on the first side of the plate, the pillars being integrally formed with the plate, wherein the pillars are disposed adjacent the apertures to prevent particles above a certain size passing through the apertures, the fluid flow direction along first and second channels during separation and concentration being approximately the same.

In a fourth aspect, the present invention provides a method for forming a separation and concentration system, the method comprising: forming a plate as defined in the third aspect from a single material.

This device and related methods described herein can be used on the macroscale or the micro- and nanoscale to refine any complex/simple liquids or complex/simple fluidics or any complex/simple gases. The device can be used for refining of inorganic or organic particles, cells, devices, macromolecules or polymers within complex/simple liquids or complex/simple fluidics or any complex/simple gas. In particular, the device allows the continuous concentration of large particles followed by the continuous separation of the smaller particles. Embodiments of the device avoid clogging that can be a problem with some prior art devices.

Additionally, it has been found that the embodiment of the device having the first and second channels formed in the plate is much easier to construct, particularly when its features are at the micron-scale and there is a much more reliable alignment of the two channels, compared to other versions that have been attempted (e.g. versions with two separate plates overlying one another, each one having a channel therein, the channels overlying one another and being aligned and connected by apertures through one of the plates).

### BRIEF DESCRIPTION OF THE FIGURES

FIG. 1A shows an exploded view of an embodiment of a separation and concentration system, in particular a plate and cover layers on either side of the plate, when viewed from the first side of the plate.

FIG. 1B shows an exploded view of an embodiment of a separation and concentration system, in particular a plate and cover layers on either side of the plate, when viewed from the second side of the plate.

FIG. 2 shows a close-up view of a portion of the first side of the plate of FIG. 1, showing the first channel, and the macro- and micropillars within it, with the apertures through the plate also being visible.

FIG. 3 shows a close-up view of a portion of the first side of the plate of FIG. 1, the scale having been expanded further from FIG. 2, such that the macropillars, the micropillars and their location relative to the aperture around which they are located, can be clearly seen.

FIG. 4 shows a close-up view of a portion of the second side of the plate of FIG. 1, showing the second channel, and the pillars within it, with the apertures through the plate also being visible.

FIGS. 5 to 9 shown the construction of a device for the continuous refining of particles, with FIG. 5 showing a housing and a support located in the housing, when viewed from an upper side of the support (i.e. a side that will face toward the plate shown in later Figures).

FIG. 6 shows an underside of the support (i.e. a side that faces away from the plate shown in later Figures) and the channels that have been formed within it.

FIG. 7 shows the housing and the support of FIG. 5, with a cover layer being located in one of the portions of the support.

FIG. 8 shows the housing and the support of FIG. 5, on which has been located a mixing system (in section A) an upstream separation and concentration system (in section B) and a downstream separation and concentration system (in section C).

FIG. 9 shows an arrangement of the device having a mixer system in section A, and separation and concentration systems in sections B, C, D, E and F, with each system being fluidly linked, as described herein, to the system downstream from it.

FIGS. 10 and 11 illustrate parts of moulds that could be used to form the features on the plates illustrated in FIGS. 1 to 4.

FIG. 12 shows various different cross sectional shapes for the pillars 107A and 107B.

FIGS. 13A and 13B show, respectively, first and second sides of an embodiment of a plate used in the Examples. The references numerals in FIGS. 13A and 13B (and all subsequent figures) are consistent with those used in FIGS. 1 to 12.

FIG. 14 shows, schematically, an array of apertures, and associated macro- and micropillars, in a hexagonal first channel (as viewed from above the first channel, with the inlet for the first channel being at the top of the Figure and the outlet for the first channel being at the bottom of the Figure).

FIG. 15 shows, schematically, an array of apertures, and associated macro- and micropillars, in a first channel that tapers toward the central portion of the channel, from both the inlet of the first channel and the outlet of the first channel (as viewed from above the first channel, with the inlet for the first channel being at the top of the Figure and the outlet for the first channel being at the bottom of the Figure).

FIG. 16 shows, schematically, an array of apertures, and associated macro- and micropillars, in a first channel that tapers toward the inlet of channel from the outlet of the channel, the tapering being along the whole length of the region occupied by the apertures (as viewed from above the first channel, with the inlet for the first channel being at the top of the Figure and the outlet for the first channel being at the bottom of the Figure).

FIG. 17 shows, schematically, an array of apertures, and associated macro- and micropillars, in a first channel that in the shape of an ellipse, with the longest axis of the ellipse extending along the direction of fluid flow along the first channel (as viewed from above the first channel, with the inlet for the first channel being at the top of the Figure and the outlet for the first channel being at the bottom of the Figure).

FIG. 18 shows, schematically, an array of apertures, and associated macro- and micropillars, in a first channel that is of a pentagonal shape (as viewed from above the first channel, with two inlet for the first channel being at the top of the Figure and the outlet for the first channel being at the bottom of the Figure).

FIG. 19 shows, schematically, an array of apertures, and associated macro- and micropillars, in a first channel that is of an irregular oval shape.

FIG. 20 shows, schematically, on the left hand side, three supports for holding plates as described herein in a circular configuration (although the plates are not shown for clarity), and, on the right hand side, a housing for the supports and plates. In this embodiment, the support is such that plates are arranged in parallel configuration, in contrast to the arrangement in FIG. 9, in which the plates are arranged in series. In other words, in the parallel arrangement, all plates on a support receive the same source of fluid, and separate it into different portions at the same time (one of the portions having large particles, i.e. the portions from the outlet of the first channels of the plates, the other of the portions having smaller particles, i.e. from the outlet of the second channel of the plates). This parallel arrangement of plates allows a large volume of fluid to be processed by the system.

FIG. 21 is a closer view of a support of FIG. 20, but in this Figure the plates are shown in place on the support, viewed from above the first side of the plates.

FIG. 22 shows, schematically, a plurality of the separation systems of FIG. 20 arranged in series.

### DETAILED DESCRIPTION

Various optional and preferred features will now be described. Any optional or preferred feature may be combined with any other optional or preferred feature and any aspect of the invention. A ‘device for the continuous refining of particles of differing properties’ may be termed a refining device herein for brevity. A ‘separation and concentration system’ may be termed a ‘separation system’ herein for brevity.

In an embodiment, the first and second channels in one of, or each of, the upstream and downstream separation systems are formed in the first and second sides, respectively, of the plate and the plurality of pillars on the first side of the plate are integrally formed with the plate. Such plates can be reliably and consistently formed from a single material, thus making manufacture simple and avoiding or minimising defects in manufacturing the device (e.g. mis-alignment of the channels, apertures and/or pillars).

A plurality of apertures are provided in the plate, the apertures allowing fluid to flow from the first channel to the second channel. Each aperture has pillars disposed around them in the first channel. The number of apertures (connecting the first and second channels) in a plate may be 5 or more, optionally, 7 or more, optionally 9 or more, optionally 10 or more, optionally 50 or more, optionally 100 or more, optionally 200 or more, optionally 300 or more, optionally 400 or more, optionally 500 or more, optionally 700 or more, optionally 1000 or more, optionally 1200 or more, optionally 1500 or more, optionally 2000 or more. In an embodiment, the number of apertures (connecting the first and second channels) is 10 to 5000, optionally 50 to 3000, optionally 50 to 2500, optionally 50 to 2000, optionally 50 to 1500. The apertures may be arranged in rows across the first channel. The apertures in each row may be offset from one another. Optionally, the number of apertures in each row decreases from the inlet of the first channel to the outlet of the first channel.

In an embodiment, around each aperture, the plurality of pillar disposed on the first side of the plate comprises a macropillar and a plurality of micropillars, the macropillar being disposed adjacent the aperture and substantially upstream from the aperture when fluid flows from the inlet of the first channel to the outlet of the first channel, the micropillars being adjacent the aperture and located substantially downstream from the macropillar. By having such an arrangement of a macropillar and a plurality of micropillars around each aperture, the clogging of the gaps between the pillars is much reduced, since the flow of fluid along the first channel is generally away from or at an oblique angle to the gaps between the pillars. The macropillar may be defined as a pillar having a larger cross-sectional area than a micropillar.

The macropillar may have a diameter, measured in a direction perpendicular to the flow from the inlet to the outlet of the first channel, that is the same as or larger than, the diameter of the aperture to which it is adjacent, measured in the same direction. Again, this assists in guiding the flow of fluid to the micropillars at the sides of the aperture or downstream therefrom.

The macropillar may have a cross-sectional shape that tapers in a direction opposite the flow from the inlet to the outlet of the first channel. This assists in creating a smooth flow of fluid past the micropillar.

In an embodiment, at least ‘n’ micropillars are disposed adjacent the aperture, wherein n is 3 or more, optionally 5 or more, optionally 7 or more, optionally 10 or more, optionally 12 or more, optionally 14 or more, optionally 15 or more, optionally 20 or more.

Optionally, the macropillars and micropillars have a cross sectional shape selected from an n-sided polygon, optionally having rounded corners and/or sides, circular, oval and ovaloid. The ‘n’ in n-sided polygon may be 3 or more, optionally 4 or more, optionally 5 or more.

In an embodiment, a plurality of pillars are disposed on the second side of the plate and extend into the second channel. Such pillars can assist in creating appropriate pressure between the first and second channels, such that there is a split in fluid flow, with some fluid passing to the outlet of the first channel and some passing to the second channel through the apertures. The plurality of pillars disposed on the second side of the plate may be integrally formed with the plate.

Each of the plurality of pillars disposed on the second side of the plate may have a cross-section shape that is elongated along the direction of flow toward the outlet of the second channel. As such, they act as a guide for the fluid flow along the second channel.

Each of the plurality of pillars disposed on the second side of the plate may be located between two apertures (in a direction perpendicular of the flow along the second channel toward the exit of the second channel).

Optionally, the first and/or second channel(s) taper(s) in a direction toward each of its/their outlet(s), optionally the channel(s) tapering along substantially the whole of its/their length that is occupied by apertures. The tapering of the channels in this manner promotes a drop in pressure and increase in flow along each of the channels.

Optionally, the first and/or second channel(s) taper(s) in a direction toward each of its/their inlet(s), optionally the channel(s) tapering along substantially the whole of its/their length that is occupied by apertures.

Optionally, the first and/or second channels are of a polygon shape, when viewed from above the relevant channel, e.g. a polygon shape having n sides, e.g. n being at least 3, e.g. selected from 3 to 8, optionally 4, 5, 6 or 7, and optionally a side of the polygon nearest the inlet of the first channel is perpendicular to the flow of the liquid. Optionally, the first and/or second channel are of a hexagonal shape.

Optionally, the first and/or second channels are of a polygon shape, when viewed from above the relevant channel, e.g. a polygon shape having n sides, e.g. n being at least 3, e.g. selected from 3 to 8, optionally 4, 5, 6 or 7, and optionally a side of the polygon nearest the inlet of the first channel is perpendicular to the flow of the liquid. Optionally, the first and/or second channel are of a hexagonal shape.

Optionally, the first and/or second channels are of a circular or an oval shape, when viewed from above the relevant channel. The oval shape may be a shape having curved sides, and no corners. The oval shape may be defined as a shape for a closed oblong shape without pointed corners. The oval shape may be selected from an ellipse and a stadium, optionally with the longest axis of the ellipse or stadium being parallel to the flow of fluid along the first channel. The oval shape may be an irregular oval shape.

Optionally, the first and/or second channels tapers toward a central portion of each of the channels, from both the inlet of the respective channel and the outlet of the respective channel.

Optionally, at least some of the surfaces of the components of the device which the fluid may contact in the device (e.g. selected from the first channel, pillars on the first side of the plate, second channel, pillars on the second side of the plate (if present)) have a coating thereon, and the coating may be a hydrophilic coating and/or a polymeric coating. The hydrophilic coating may be a hydrophilic polymer, e.g. a polyethylene glycol polymer. This has been found to increase the separation efficiency of the device. The coating may also be used to decrease the separation distance between adjacent pillars, i.e. reduce it further from the plate as produced, e.g. from a single piece of material, e.g. in an injection-moulding process.

Optionally, the first and second channels are each covered by a cover layer adhered to the plate to seal the channels. The cover layer is preferably adhered to the surface of the plate surrounding the first and second channels and their inlets and outlets. The cover layer is preferably adhered to the ends of the pillars disposed on the first side of the plate and, if present, the ends of the pillars disposed on the second side of the plate.

The device may further comprise a mixer for homogenising a fluid, the mixer being fluidly connected to the first and/or second channels of the upstream or downstream separation and concentration system. The mixer may be a microfluidic mixer. The mixer may comprise a channel that has a plurality of abrupt turns in it (e.g. turns of an angle of 120° or less, e.g. turns of about 90°) to effect turbulence in the fluid flowing through the channel. Alternatively or in addition, a mixer system may be disposed downstream from one or more of the separation and concentration system, to effect homogenisation as desired and/or to enable mixing with other fluids.

The device may comprise a support, and optionally the plates of the upstream and downstream separation and concentration systems are removable from the support, the support having conduits therein, for transferring fluid from the outlet of the second channel of the upstream separation and concentration system to the inlet of the first channel of the downstream separation and concentration system.

The support may further comprise a conduit for passing fluid to the inlet of the upstream separation and concentration system and a conduit for removing fluid from the outlet of the downstream separation and concentration system.

The separation distance between two adjacent pillars adjacent an aperture on the first side of the plate of the upstream separation and concentration system may be 5 mm or less, optionally 3 mm or less, optionally 1 mm or less, optionally 750 μm or less, optionally 500 μm or less, optionally 400 μm or less, optionally 300 μm or less, optionally 200 μm or less, optionally 100 μm or less, optionally 50 μm or less, optionally 20 μm or less, optionally 10 μm or less, optionally 5 μm or less, optionally 1 μm or less, optionally 750 nm or less, optionally 500 nm or less. The separation distance between two adjacent pillars adjacent an aperture on the first side of the plate of the upstream separation and concentration system may be 500 nm or more, optionally 750 nm or more, optionally 1 μm or more, optionally 5 μm or more, optionally 10 μm or more, optionally 20 μm or more, optionally 50 μm or more, optionally 100 μm or more, optionally 200 μm or more, optionally 300 μm or more, optionally 400 μm or more, optionally 500 μm or more, optionally 750 μm or more, optionally 1 mm or more, optionally 3 mm or more, optionally 5 mm or more. The separation distances between two pillars adjacent an aperture may the same for all pillars on the first side of the plate or may vary across or along the first side of the plate, as desired.

The separation distance between adjacent pillars on the first side of the plate in the upstream system is more than the separation distance between adjacent pillars on the first side of the plate in the downstream system. If the separation distances between pillars varies on a plate, then the largest separation distance between adjacent pillars on the first side of the plate in the upstream system is more than the largest separation distance between adjacent pillars on the first side of the plate in the downstream system.

As mentioned, there is provided a method for the continuous separation and concentration of particles of differing properties, the method comprising:
providing a device according the first aspect,
inputting a fluid comprising a mixture of particles of varying properties into the first channel of the upstream separation system, such that the fluid flows along the first channel to the plurality of apertures, with some of the fluid (a first portion) passing along the outlet of the first channel,
and some of the fluid (a second portion) passing through the apertures into the second channel and through the output of the second channel of the upstream separation system to the input of the first channel of the downstream separation system,
the second portion of the fluid passing along the first channel of the downstream separation system to the plurality of apertures, with some of the fluid (a third portion) passing along the outlet of the first channel and some of the fluid (a fourth portion) passing through the apertures into the second channel and through the output of the second channel of the downstream separation system,
optionally wherein the first portion of fluid has a higher concentration of larger particles than the fourth portion of fluid.

The fluid may comprise any substance that can flow, including a gas and a solid. The fluid may be a complex or simple liquid and may include any complex or simple phase or mixture including solid, liquid or gas solutions as defined by Jean-Louis Barrat and Jean-Pierre Hansen 1964-2003: ISBN 0-521-78344-5 ISBN 0-521-7895-2.

The fluid has therein particles with differing properties. Such properties may be selected from different sizes, shapes, contents and density. The particles are typically suspended in the fluid. The particles may comprise a plurality of biological entities. The biological entities may be selected from cells, cell components (such as nucleus, mitochondria, golgi apparatus, endoplasmic reticulum, ribosomes, lysosomes), viruses, DNA, proteins and smaller organelles such as exosomes or living micro vehicles. The fluid may comprise one or more macromolecules, e.g. macromolecules selected from DNA, RNA and proteins. The fluid may comprise particles, e.g. inorganic or organic particles, of different properties, e.g. different sizes. Inorganic particles may be metal compounds, e.g. metal oxides. Organic particles may be polymeric particles. With appropriate spacings between the pillars in the upstream and downstream separation and concentration systems, the device can separate different types of particle, e.g. different types of biological entities, e.g. different types of cell (e.g. cells that differ in size). It may, for example, be used to separate bacteria and/or viruses and/or other parasites from one another or from other biological entities. In an embodiment, the device may be used to separate components in a fluid containing biological entities from human or animals. In an embodiment, the device may be used to separate components in a fluid containing biological entities from fish, such as fish mucosa, tissue and/or blood. In an embodiment, the fluid may be selected from sea water, river water and lake water. In an embodiment, the fluid contains parasites and/or animals, e.g. microparasites and/or microanimals. In an embodiment, the fluid contains lice, e.g. sea lice, e.g. salmon lice. In an embodiment, the method is used to remove and concentrate any of the biological entities mentioned above from a fluid, e.g. water. In an embodiment, the method is used to remove and concentrate any of the biological entities, including parasites or animals, mentioned above from a fluid, e.g. water. In an embodiment, the method may be used to purify water by removing undesired entities from the water that may be harmful to health, e.g. a species selected from parasites, bacteria and viruses.

In an embodiment, the device or system herein may be used for one or more of:
production of clean water;
production of clean water without pressure drop and without chemicals;
production of clean water in combination with valuable particles and cell purification and concentration;
large volume clean water production without pressure drop and the use of chemicals;
removal of disease-causing microparasites from water
concentration of microparasites for more accurate monitoring to confirm pure water—(this allows the treatment only water that is a problem to the production process of fish);
collecting, sorting and concentration biomasses from sea water, which may be large volumes of biomasses from large volumes of sea water or sediments from water or other fluid.

In the method, particles above a first certain size (typically larger than the separation distance between adjacent pillars in the first channel in the upstream system) are prevented in the upstream system from passing into the second channel and therefore pass to the outlet of the first channel (and collected in the first portion of fluid). The fluid exiting the second channel in the upstream system (the second portion of fluid) will typically lack or substantially lack particles above the first certain size. In the downstream separation system, particles above a second certain size (typically larger than the separation distance between adjacent pillars in the first channel in the downstream system) are prevented from passing into the second channel and therefore pass to the outlet of the first channel (and collected in the third portion of fluid). The fluid exiting the second channel in the upstream system (the fourth portion of fluid) will typically lack or substantially lack particles above the second certain size. Accordingly, particles of different sizes can be separated using the device of the present application. The separation distance between pillars will typically be progressively smaller for each separation and concentration system (as fluid flows downstream), allowing progressively smaller particles to be removed from each system. As an example, in the upstream separation and concentration system, particles larger than 25 μm may be removed from the system, and a plurality of downstream separation and concentration system are provided, the first of which removes particles larger than 12 μm, the second of which removes particles larger than 5 μm, the third of which removes particles larger than 0.5 μm, the fourth of which removes particles larger than 0.25 μm, the fifth of which removes particles larger than 80 nm.

In an embodiment, before passing the fluid to the upstream separation and concentration system, the fluid is passed through a mixer system, to homogenise the fluid. The fluid may be passed through a system that subjects the fluid to turbulence mixing and/or mixing by diffusion. The mixer may for example comprise a channel that has a plurality of abrupt turns in it (e.g. turns of about 90°) to effect turbulence in the fluid flowing through the channel. Alternatively or in addition, a mixer system may be disposed downstream from one or more of the separation and concentration system, to effect homogenisation as desired and/or to enable mixing with other fluids.

Herein is also provided a separation and concentration system comprising:
a plate having opposing first and second sides, each of first and second sides having formed therein first and second channels, respectively, the first and second channels being fluidly connected to one another by a plurality of apertures through the plate that allow fluid flow from the first to the second channel, and
a plurality of pillars are disposed on the first side of the plate, the pillars being integrally formed with the plate, wherein the pillars are disposed adjacent the apertures to prevent particles above a certain size passing through the apertures, the fluid flow direction along first and second channels during separation and concentration being approximately the same. The features of the separation and concentration system may be as described herein.

Herein is also provided a method for forming a separation and concentration system, the method comprising: forming a plate as defined above from a single material. The plate may formed by injection moulding a plastic. The plate may be formed by injection moulding a plastic into a mould, the mould having projections for forming the first and second channels in the plate and apertures through the plate, and recesses for forming the plurality of pillars on the first side of the plate, and, optionally recesses for forming the plurality of pillars on the second side of the plate (if present).

In other embodiments, the plate may be formed using other replication methods that involve use of a template or master (which may be in negative form to the plate that is produced), including, but not limited to, hot embossing, casting, soft lithography. The plate may also be formed using direct fabrication methods, including, but not limited to, 3D-printing, mini-milling, laser ablation, plasma etching, X-ray lithography, stereolithography, SU-8 LIGA, and layering.

The plate may comprise a polymer material. The plate may comprise a polymer material selected from cyclic olefin copolymer/polymer (COC/COP), polycarbonate (PC), polymethylmethacrylate (PMMA), polyethylene terephathalate (PET), polyetherketone (PEEK), polyimide (PI), polydimethylsiloxane (PDMS), polytetrafluoroethylene (PTFE) and SU-8.

The cover layer that may be disposed over the first and/or second side of the plate may be a film of a polymeric material or a layer of a non-polymeric material, such as glass or silicon wafer. The film of a polymeric material may comprise a polyolefin, e.g. polyethylene and/or polypropylene. The cover layer that may be disposed over the first and/or second side of the plate may have adhesive disposed on a side of the cover layer for adhesion to the plate. The cover layer may be adhered to the plate by any suitable means, such as adhesive or by welding the materials of the plate and the cover layer together (e.g. using a plastic welding technique, if both the plate and cover layer are plastic). In an embodiment, the adhesive is a pressure sensitive adhesive. In an embodiment, the adhesive is a silicone adhesive. The cover layer, before being applied to the plate, may have a layer of already-applied adhesive thereon, such as a pressure sensitive adhesive, and the adhesive may be a silicone adhesive. Suitable cover plates are available commercially, e.g. PCR plate seals, available from Thermo Scientific and Eppendorf Adhesive Seals for Microplates, an example of which is their Masterclear product, or from Axygen Inc.,®, e.g. their product under the tradename Platemax Ultraclear Sealing Film.

The cover layer is preferably transparent or translucent, such that the channels underlying the cover layer in the plate and any fluids in them can be seen through the cover layer. The cover layer on the first side of the plate is preferably a continuous layer that covers and seals the first channel. The cover layer on the second side of the plate is preferably a continuous layer that covers and seals the second channel, but the film may have one or more apertures therein through which fluid may exit the outlets of the first and second channels. An aperture may be provided through the plate to allow fluid to flow through the plate from the second side of the plate to the inlet of the first channel on the first side of the plate.

In an embodiment, there is provided a method comprising passing a fluid into the separation and concentration system as described herein, such that fluid passes along the first channel, and some of the fluid (a first portion) passing out of an outlet of the first channel on the first side of the plate (i.e. not having passed through the apertures to the second channel) and some of the fluid passing through the apertures from the first channel to the second channel and out of an outlet of the second channel. The fluid may comprise particles of differing properties as described herein.

Also provided is the use of the device or system described herein to process fluid, which may be fluid comprising particles of differing properties as described herein.

In an embodiment, there is provided a system comprising a plurality of plates described herein, wherein the plates are arranged in parallel, such that the plates are fed from the same source of fluid, such that the fluid passes into the inlet of the first channel of each plate, and optionally the fluid from the outlet of each of the first channel (i.e. not having passed through the apertures to the second channel) is collected and optionally combined, and optionally the fluid from the outlet of each of the second channels (i.e. having passed through the apertures from the first channel to the second channel) is collected and optionally combined. Optionally, a plurality of systems, each comprising a plurality of plates described herein, are arranged in series, such that fluid from the outlets of second channels of an upstream system is fed into the inlets of the first channels of a downstream system. The plates in a system may optionally be arrange in a circular configuration.

Further non-limiting embodiments of the present invention will now be described with reference to the Figures. Any individual feature described with reference in the Figures may be combined with the aspects described herein.

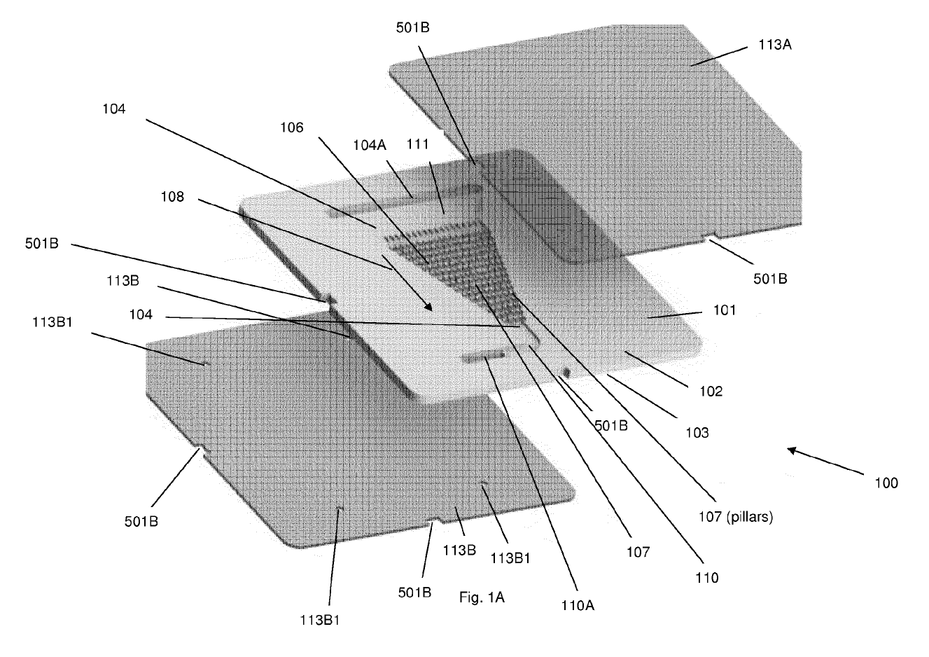

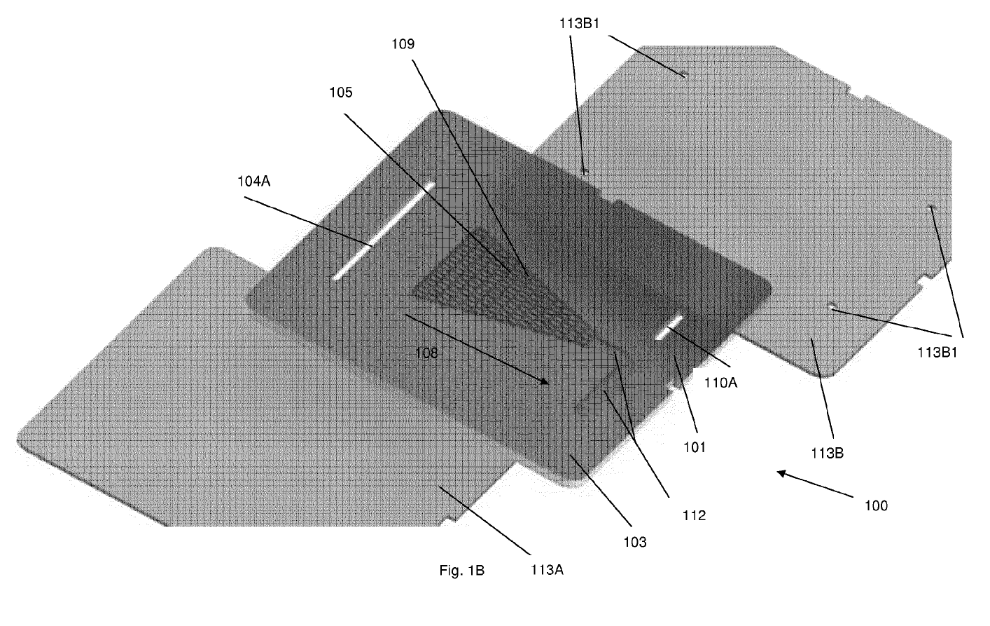

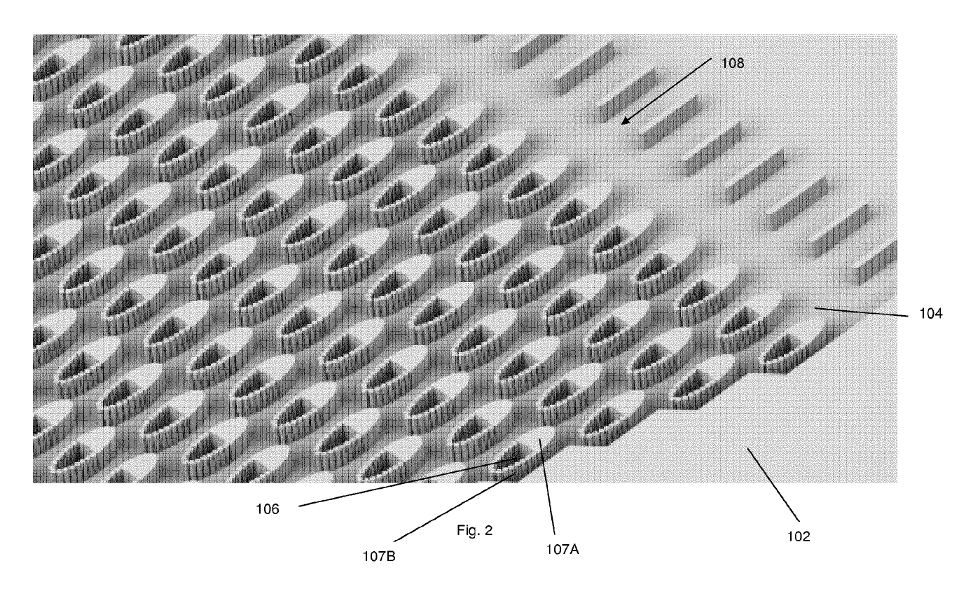

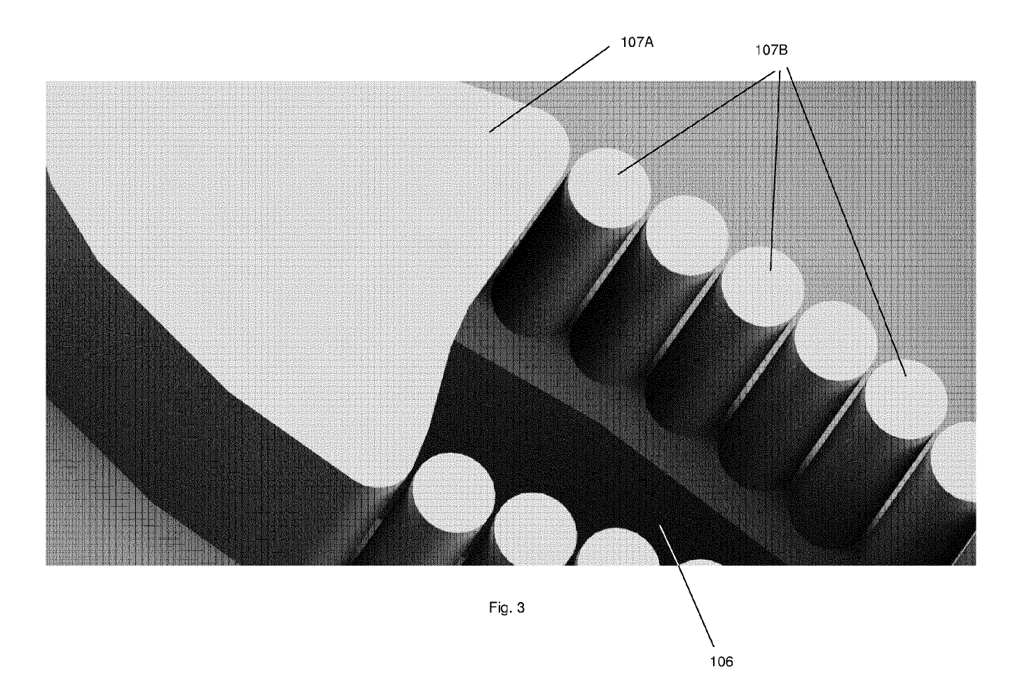

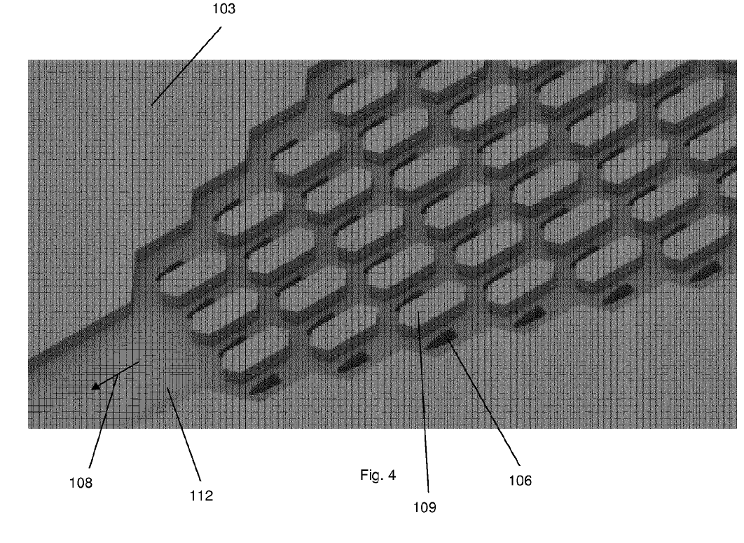

FIG. 1A illustrates a separation and concentration system 100, which may serve as the upstream or downstream system of the device for continuous refining of particles. In this Figure is shown a plate 101 having a first side (102) and a second side (103—not visible in this Figure, but see FIGS. 1B and 4). The plate in FIG. 1A is viewed from above the first side. The plate and all its component parts are integrally formed from a single polymeric material, which may be a polymer mentioned above. The plate has formed in its first side a first channel 104. An aperture 104A is provided through the plate at the start of first channel 104, the aperture 104A stretching substantially across the whole of the first channel 104. On the opposite side (not shown in FIG. 1A, but shown in FIGS. 1B and 4) of the plate, i.e. on the second side, is a second channel 105, the second channel lying underneath the first channel. In use, the fluid flow direction 108 along first channel during separation is approximately the same as in the second channel. The first and second channels are fluidly connected to one another by a plurality of apertures 106 through the plate that, in use, allow fluid flow from the first to the second channel 105. The plate has an outlet 110 from the first channel downstream from the plurality of apertures on the first side of the plate. Around each aperture on the first side of the plate is disposed a plurality of pillars 107. In use, these pillars act to prevent particles above a certain size passing through the aperture, by virtue of the spacing, or separation distance, between the pillars. The plurality of pillars around each aperture comprises a macropillar 107A and a plurality of micropillars 107B. The micropillar 107A has a larger cross-sectional area than the micropillars 107B. The macropillar is disposed adjacent the aperture and substantially upstream (i.e. closer to the inlet 111 than the outlet 110 of the first channel) from the aperture 106 when fluid flows from the inlet 111 of the first channel to the outlet 110 of the first channel 104. The micropillars adjacent the aperture are located substantially downstream from the macropillar, i.e. closer to the outlet 110 of the first channel. These pillars and their arrangement around the apertures are shown in FIGS. 2 and 3. The macropillar has a diameter, measured in a direction perpendicular to the flow from the inlet to the outlet of the first channel, that is larger than the diameter of the aperture to which it is adjacent, measured in the same direction. The macropillar has a cross-sectional shape that tapers in a direction opposite the flow from the inlet to the outlet of the first channel (i.e. it narrows toward the inlet of the first channel). The micropillars here have a circular cross-sectional shape. Fifteen micropillars are disposed around each aperture. The distance between two adjacent micropillars is the same for all pairs of adjacent pillars, which is also the same for as the distance between the macropillar and the closest micropillar.

As shown in FIGS. 1 and 4 the first 104 and second 105 channel taper in a direction toward each of their outlet(s). It can be seen that the channels taper along substantially the whole of their length that is occupied by apertures.

FIG. 3 shows a view of part of the plate from above its second side. The apertures 106 can be seen. It can also be seen that a plurality of pillars are disposed on the second side of the plate and extend into the second channel. The plurality of pillars disposed on the second side of the plate have a cross-section shape that is elongated along the direction of flow toward the outlet of the second channel. Each of the end portions of the pillars (the end portions closest to and further from the outlet of the second channel) taper to a point. Each of the plurality of pillars disposed on the second side of the plate is located between two apertures (in a direction perpendicular of the flow along the second channel toward the exit of the second channel).

In use, each of the first and second channels are covered by a cover layer 113A, 113B adhered to the plate 101 to seal the channels. The cover layer 113A, 113B is adhered to the ends of the pillars 107 disposed on the first side of the plate and the ends of the pillars 107 disposed on the second side of the plate.

In the device for refining of particles, upstream and downstream separation and concentration systems, in the design shown in FIGS. 1A and 1B, are fluidly linked in sequence. Here, the upstream separation system has an outlet from the second channel that is fluidly linked to the inlet of the first channel of the downstream separation system. The separation distance between adjacent pillars in the upstream system is more than the separation distance between adjacent pillars in the downstream system.

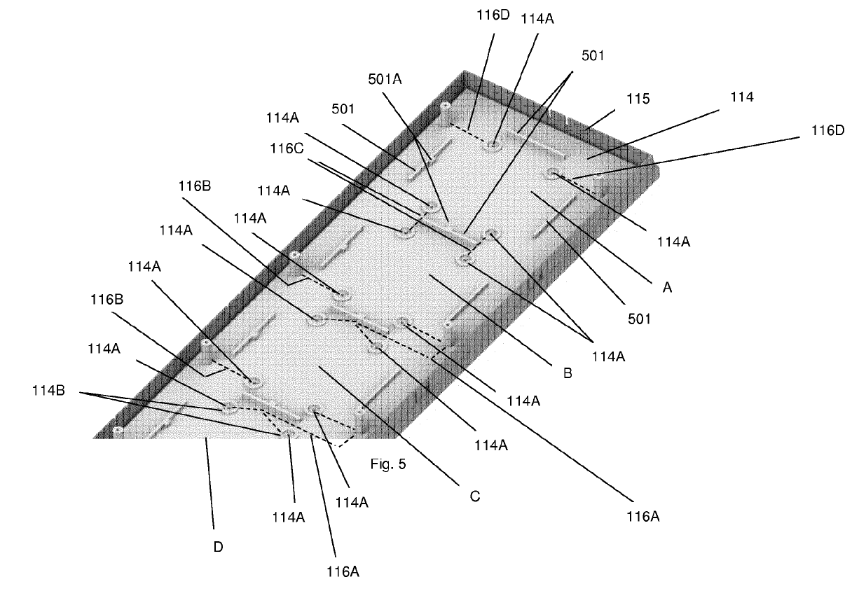

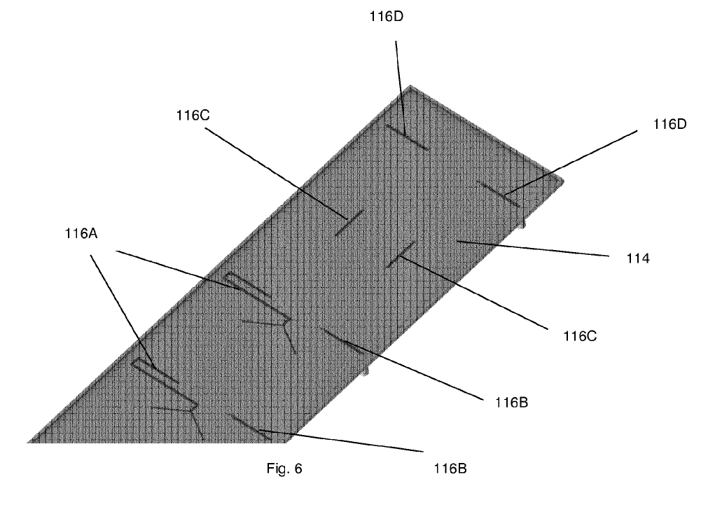

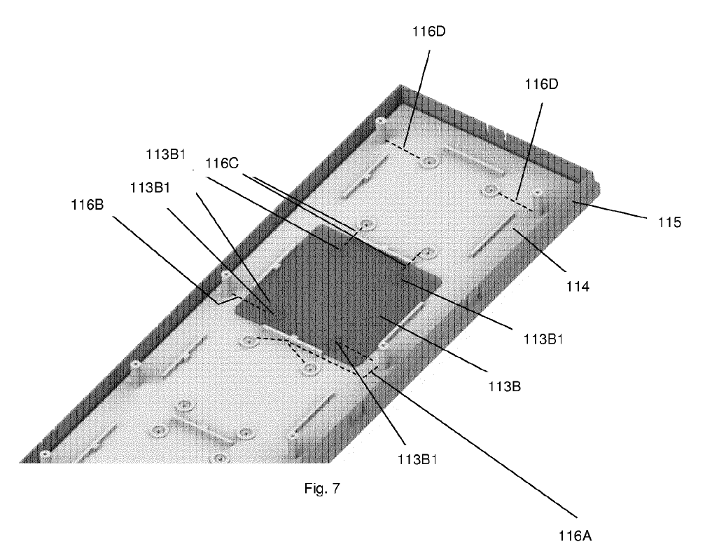

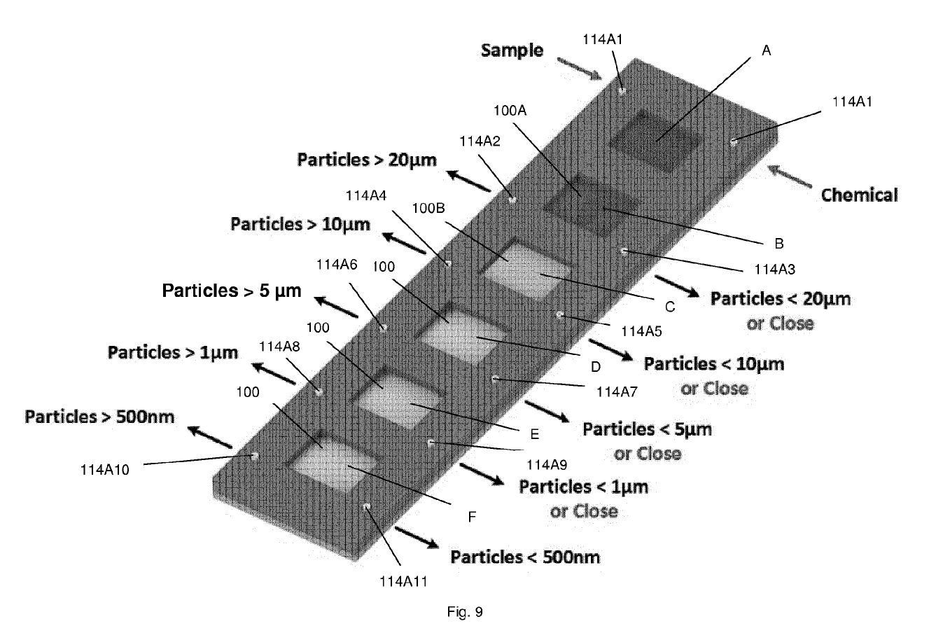

FIGS. 5 to 9 shown the construction of a device for the continuous refining of particles. FIG. 5 shows a support 114, which is held within (but removable from) a housing 115. The underside of the support 114 is shown in FIG. 6. The support comprises number of integrally formed channels 116A, 116B, 116C and 116D, which will be termed conduits, for passing fluid from one upstream system to the downstream system, and to outlets and inlets of the systems. In particular, the conduits 116A are for passing fluid from the exit of the second channel of an upstream system to the inlet of first channel of the next downstream system. The conduits 116B would, in use, be fluidly connected to the outlet of the first channel, allowing collection of fluid from this outlet. The conduits 116 A, B, C and D would not be visible from the side of the support shown in FIG. 7 (unless the support was transparent), but their positions are shown in FIG. 5 by dotted lines. In use, as is shown in FIG. 9, an upstream system resides in section B of support and downstream systems reside in sections C, D and so on.

The support has various features as shown in FIG. 5, which will be discussed below. It can be seen that locating walls 501 are provided on the support 114, each of which will hold the plates of the mixer system or separation and concentration system in place and prevent lateral movement thereof. They act as a guide and each wall, in use, abuts a side of a plate, so that the various apertures in the plates align with the corresponding apertures in the underlying cover layer and support. Protrusions 501A are located on two locating walls, these protrusions corresponding to indents 501B in the sides of the plate 101 and cover layers 113A and 113B thereon. By locating the protrusions 501A on two adjacent walls 501 (i.e. walls at right angles to one another in the Figure), and if the plate is rectangular (i.e. having sides of different length) this ensures that the plate can only be inserted in the correct orientation (with the second side of the plate facing the support), in view of the asymmetry in the plate.

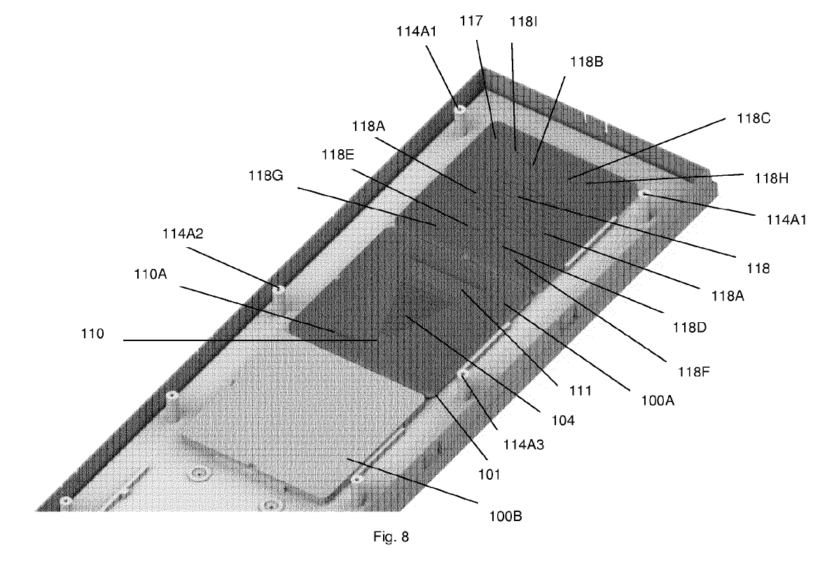

In some embodiments, a mixing system 117 may be located upstream of the separation and concentration systems. As shown in FIGS. 8 and 9, this would be in section A of the support. The mixing system 117 may be used to homogenise a fluid before it reaches the most upstream of the separation and concentration systems. It also may be used to mix two fluids together. The mixer system may be a plate having a channel 118 therein or thereon that has a plurality of abrupt turns 118A that serve to cause turbulence in the fluid as it passes along the channel. In the embodiment shown in FIG. 8, the channel 118 has two inputs 118B and 118C, which, in use, would be fluidly connected to the conduits 116D in the support (shown in FIGS. 5 and 6).

FIG. 7 shows a cover layer 113B in place on the support before the plate 101 has been placed on it. The cover layer 113B has apertures 113B1 therein. It should also be noted that the support 114 has apertures 114A therethrough, each of which forms a fluid connection with one of the conduits 116A, 116A, 116B, 116C and 116D. Around each aperture 114A is a raised annular portion 114B, i.e. a ring-shaped member raised above the generally flat surface of the support 114. When the cover layer 113B is placed in section B on the support, each of apertures 113B1 in the cover layer correspond with each of the apertures 114A in the support. The raised annular portion 114B forms a seal around each of the apertures 113B1 in the cover layer.

FIG. 8 shows the mixing system 117, an upstream separation and concentration system 100A and a downstream separation and concentration system 100B on the support. (Channels are not shown in the downstream system, for simplicity purposes). Underlying each of the systems 117, 100A and 100B, is a cover layer 113B (although this cannot be seen in this Figure), with each cover layer having apertures 113B1 that correspond with underlying apertures 114A in the support. The inlets 118B and 118C of the mixer system are fluidly connected to inlet tubes 114A1, each of which has an aperture extending along its length that is fluidly connected with conduits 116D on the underside of the support, which in turn are fluidly connected with the apertures 114A in the support, which are fluidly connected with the apertures 113B1 in in the overlying cover layer 113B, which in turn are fluidly connected to apertures 118H and 118I in the plate of the mixer system that are connected to the inlets 118B and 118C, respectively.

The outlets 118D and 118E of the channel 118 in the mixer system 117 are fluidly connected to the inlet 111 of the first channel 104 in the upstream separation and concentration system 100A, via apertures 118F and 118G that extend through the plate of the mixer system, each of which lie above an aperture 113B1 in the cover layer below, which lies above aperture 114A, which is fluidly connected to the conduit 116C, which in turn is fluidly connected to the inlet 111 of the first channel via apertures 114A in the support, 113B1 in the cover layer, and overlying aperture 104A in the plate 101 that is located at the start of the first channel 104.

Similarly, the outlet 110 for the first channel 104 in the upstream separation and concentration system 100A is fluidly connected to outlet tube 114A2 via conduit 116B and apertures 114A in the support, 113B1 in the cover layer and aperture 110A through the plate 101.

The outlet 112 for the second channel 105 (not visible in FIG. 8) in the upstream separation and concentration system 100A is fluidly connected to the inlet 111 of the first channel of the downstream separation system via conduit 116A and apertures 114A in the support, and 113B1 in the cover layer. Also fluidly connected to conduit 116A is tube 114A3, that can be used to draw off a sample from conduit 116A or be used to inject fluid into the system.

FIG. 9 shows an arrangement of the device having a mixer system 117 in section A, and separation and concentration systems 100 in sections B, C, D, E and F, with each system being fluidly linked, as described above, to the system downstream from it.

In use, a sample containing a plurality of particulates of different sizes can be passed into one of the inlet tubes 114A1, and, if desired, a further fluid (denoted ‘chemical’) can be passed into the other inlet tube 114A1. The fluid passes into the channel 118 of the mixer system 118 and becomes homogenised as it passes through it. The fluid then passes into the upstream separation and concentration system 100A in section B. Fluid passes into the first channel 104 and the flow is then split, such that (i) some of the fluid passes to the exit 110 of the first channel 104 and then to the outlet tube 114A2, and (ii) some of the fluid passes through into the second channel and onto the downstream separation and concentration system 100B in section C. Again, the fluid is split in the downstream system, such that some of it exits from the first channel and is collected from outlet tube 114A4 and some of it is passed, via the second channel, to the next separation and concentration system 100. The gaps between the pillars 107 on the first side 102 of the plate 101 become increasingly smaller for each separation and concentration system as the fluid is passed downstream. Accordingly, the particles collected upstream will be larger than those collected downstream. In FIG. 9 is a schematic illustration of how the particles of different sizes can be separated using the device. At exit 114A2, the fluid contains a high concentration of particles having a particle size greater than 20 microns are collected (by virtue of the gaps between adjacent pillars in the first channel not being greater than 20 microns, to prevent particles of 20 microns or more passing in to the second channel). Accordingly, fluid containing particles having dimensions of 20 microns or less is passed to the downstream separation and concentration system 100B (a sample of this fluid may be taken via tube 114A3). In the downstream separation and concentration system 100B, the flow of fluid is again split, such that some exits the outlet of the first channel and some is passed to the second channel. The fluid from the outlet of the first channel is passed to outlet tube 114A4, and this contains a high concentration of particles having a particle size of more than 10 microns or more (by virtue of the gaps between adjacent pillars in the first channel of this downstream system not being greater than 10 microns, to prevent particles of 10 microns or more passing in to the second channel). Accordingly, fluid containing particles of 10 microns or less are passed to the next separation and concentration system (an a sample of this fluid can be drawn from tube 114A5).

As each separation and concentration system has a smaller gap between pillars, successively smaller particles can be concentrated and collected from the outlet tubes. As an illustration in FIG. 9, this allows particles of above 50 microns, above 1 micron and above 500 nm to be collected.

The above particle sizes are mentioned only as illustration and they may be determined as desired with the selection of separation and concentration systems having appropriate gaps between the pillars. Since the separation and concentration systems and the mixer system are removable, any desired arrangement may be employed to separate and concentrate particles of desired sizes.

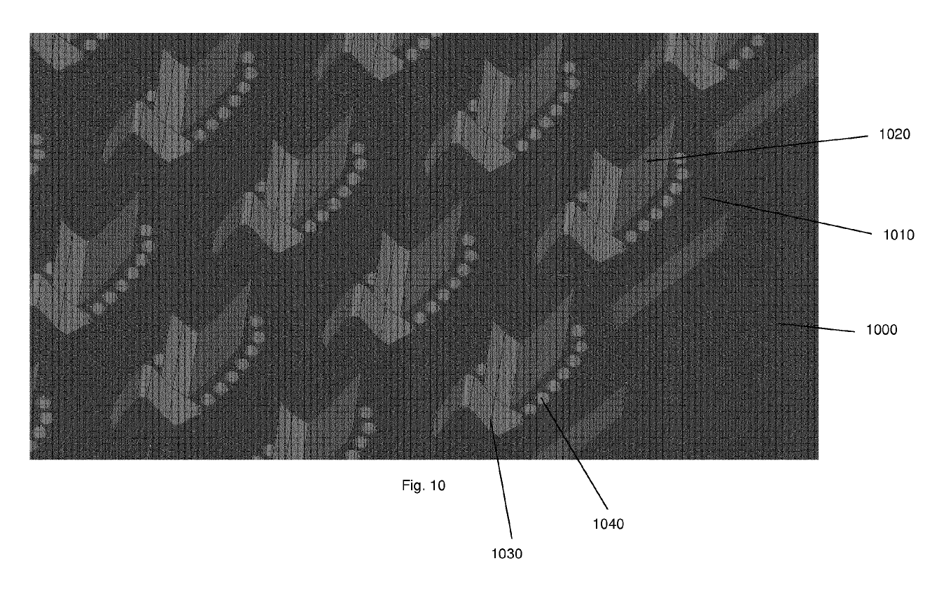

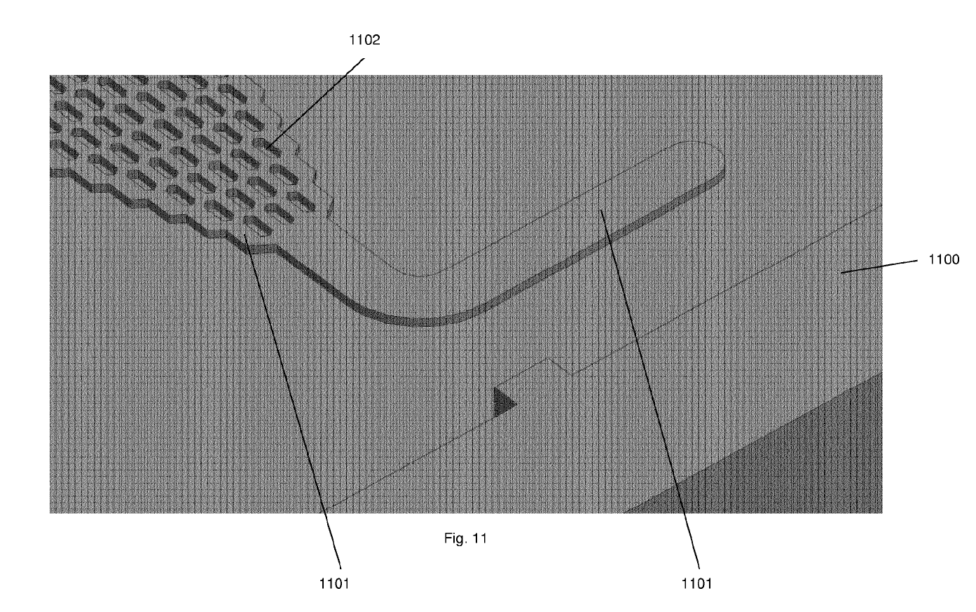

The device may be constructed in any suitable manner. The separation and concentration system may be made by, for example, injection moulding. FIGS. 10 and 11 illustrate parts of moulds 1000, 1100 that could be used to form the features on the plate. FIG. 10 shows, for example, a portion of a mould 1000 for creating the features on the first side 102 of the plate 101, the mould 1000 having a raised, tapering flat portion 1010 (which corresponds to the first channel 104 in the plate 101), on which are protrusions 1020 (which correspond to the apertures 106 through the plate). The raised, tapering flat portion 1010 also has indentations 1030 and 1040. The larger indentations 1030 correspond to the macropillars 107A and the smaller indentations 1040 correspond to the micropillars 107B.

FIG. 11 shows, for example, a portion of a mould 1100 for creating the features on the second side 103 of the plate 101, the mould 1100 having a raised portion 1101 for creating the second channel 105 and its outlet 112, the raised portion having indentations 1102 for forming the pillars 109 in the second channel 105.

The moulds may produced using a milling techniques, which has found to be particularly suitable for producing plates having gaps of 20 μm or more between adjacent pillars. To produce plates having less than 20 μm between the pillars, it has been found that techniques such as ion beam lasers or x-ray lasers are more suitable to make the indentations 1030, 1040 in the mould that will form the pillars 107A and 107B.

In forming a plate 101, the moulds 1000 and 1100 would be aligned such that the first and second channels overlie one another. A plastic could then be injection moulded between the moulds, thus forming the plate 101.

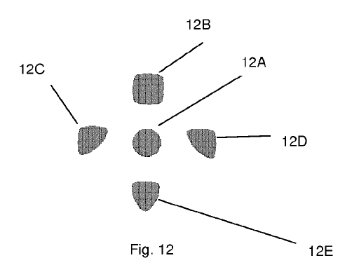

FIG. 12 shows various different cross sectional shapes for the pillars 107A and 107B, namely circular 12A, approximately square (with rounded corners, and curved sides) 12B, triangular (with rounded corners, and curved sides) 12C, 12D, and 12E, with the triangles differing by the angles within them (12C and 12D being approximately right-angled, isosceles triangles, and 1E being approximately an equilateral triangle). Non-circular shapes may be used to create a pressure drop over the system even when the distance between the pillars is less than 20 micrometer.

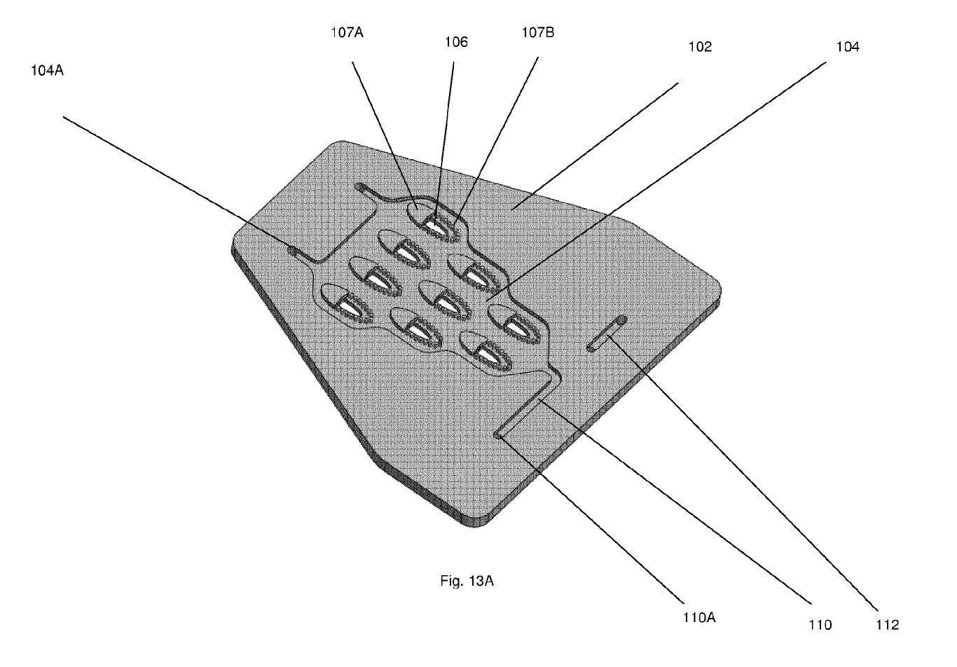

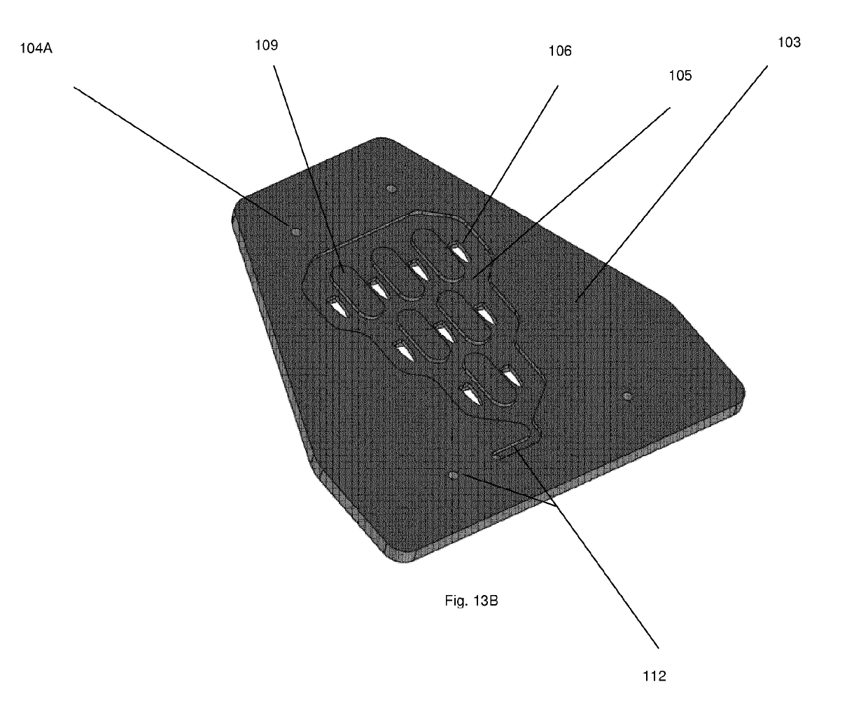

FIGS. 13A and 13B show first and second sides of an embodiment of a plate used in the Examples.

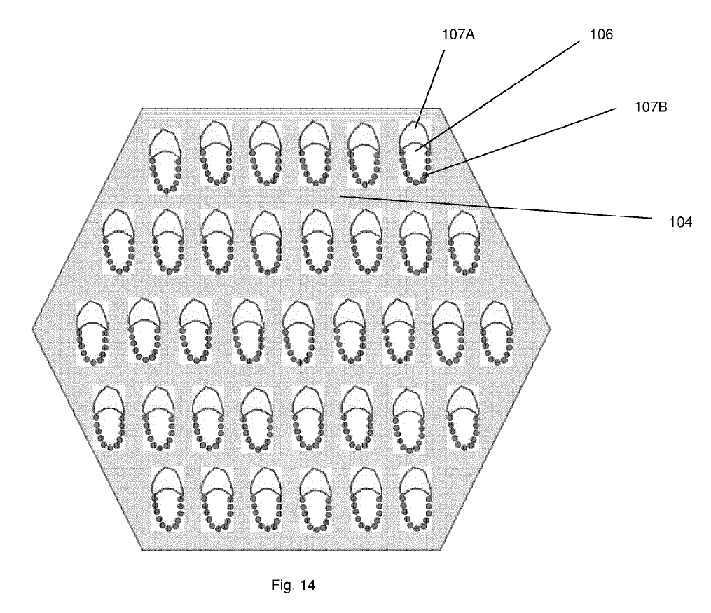

FIG. 14 shows, schematically, an array of apertures, and associated macro- and micropillars, in a hexagonal first channel (as viewed from above the first channel, with the inlet for the first channel being at the top of the Figure and the outlet for the first channel being at the bottom of the Figure.

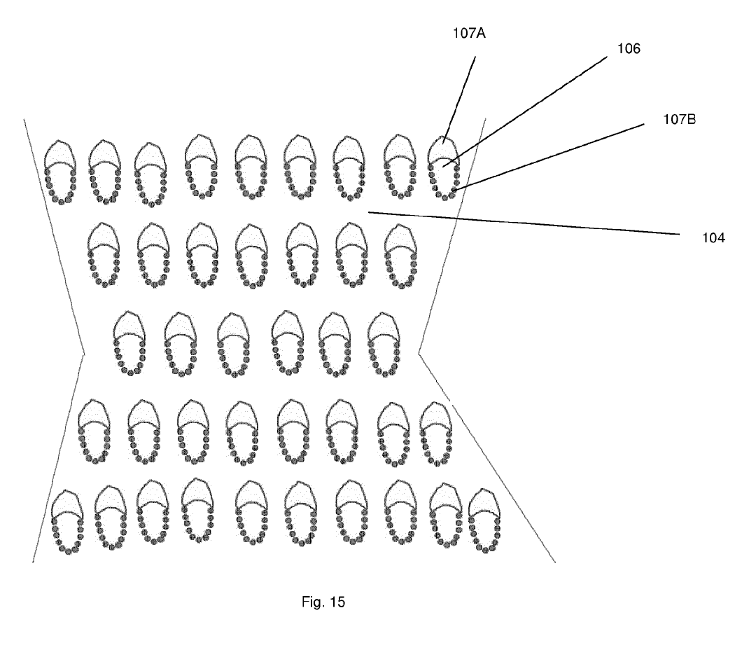

FIG. 15 shows, schematically, an array of apertures, and associated macro- and micropillars, in a first channel that tapers toward the central portion of the channel, from both the inlet of the first channel and the outlet of the first channel (as viewed from above the first channel, with the inlet for the first channel being at the top of the Figure and the outlet for the first channel being at the bottom of the Figure).

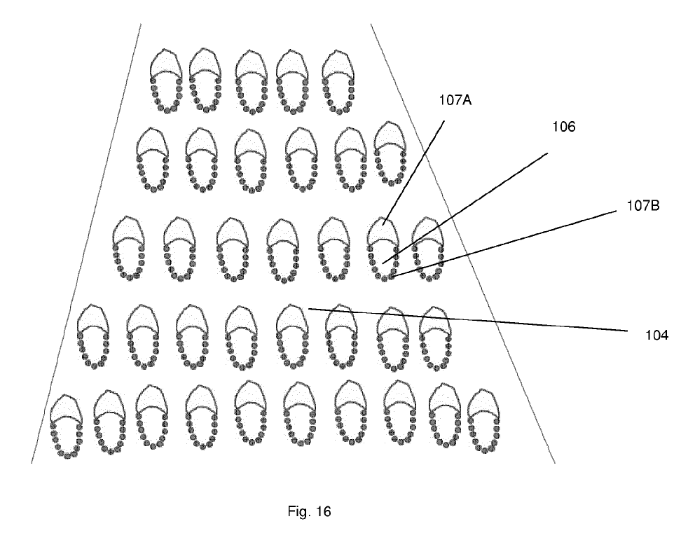

FIG. 16 shows, schematically, an array of apertures, and associated macro- and micropillars, in a first channel that tapers toward the inlet of channel from the outlet of the channel, the tapering being along the whole length of the region occupied by the apertures (as viewed from above the first channel, with the inlet for the first channel being at the top of the Figure and the outlet for the first channel being at the bottom of the Figure).

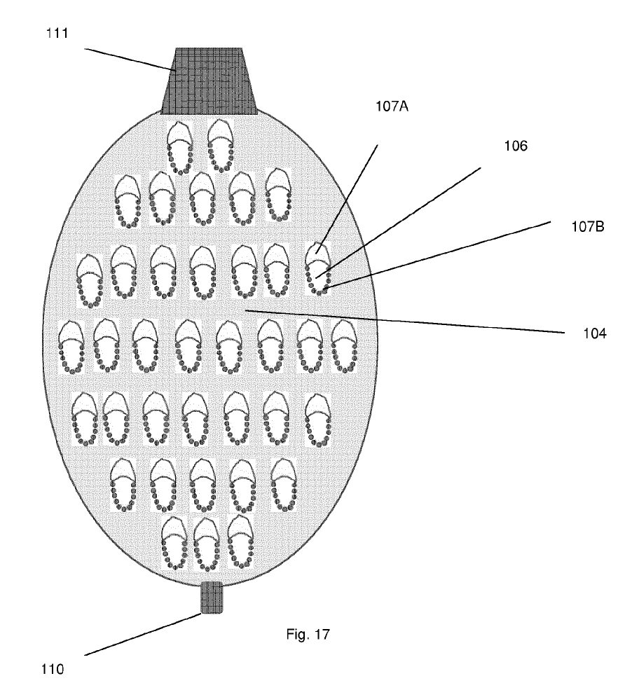

FIG. 17 shows, schematically, an array of apertures, and associated macro- and micropillars, in a first channel that in the shape of an ellipse, with the longest axis of the ellipse extending along the direction of fluid flow along the first channel (as viewed from above the first channel, with the inlet for the first channel being at the top of the Figure and the outlet for the first channel being at the bottom of the Figure).

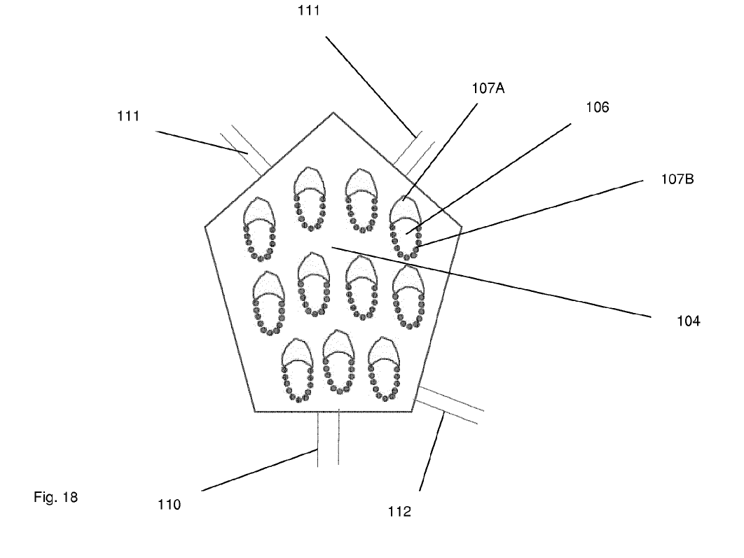

FIG. 18 shows, schematically, an array of apertures, and associated macro- and micropillars, in a first channel that is of a pentagonal shape (as viewed from above the first channel, with two inlet for the first channel being at the top of the Figure and the outlet for the first channel being at the bottom of the Figure).

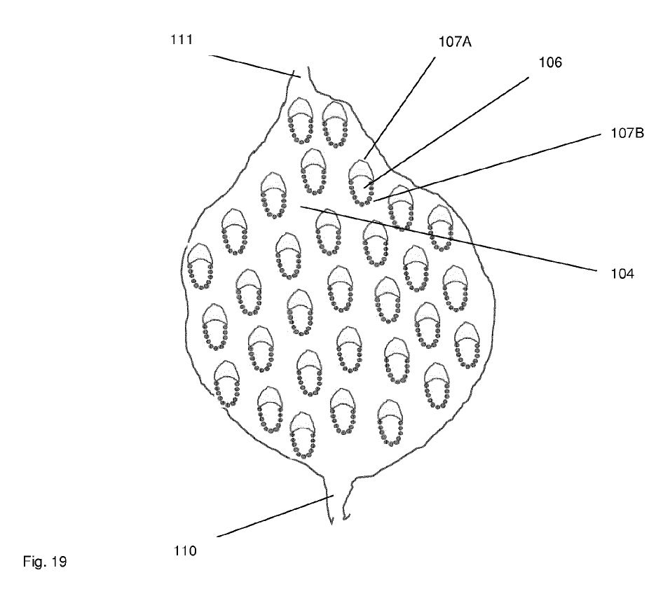

FIG. 19 shows, schematically, an array of apertures, and associated macro- and micropillars, in a first channel that is of an irregular oval shape.

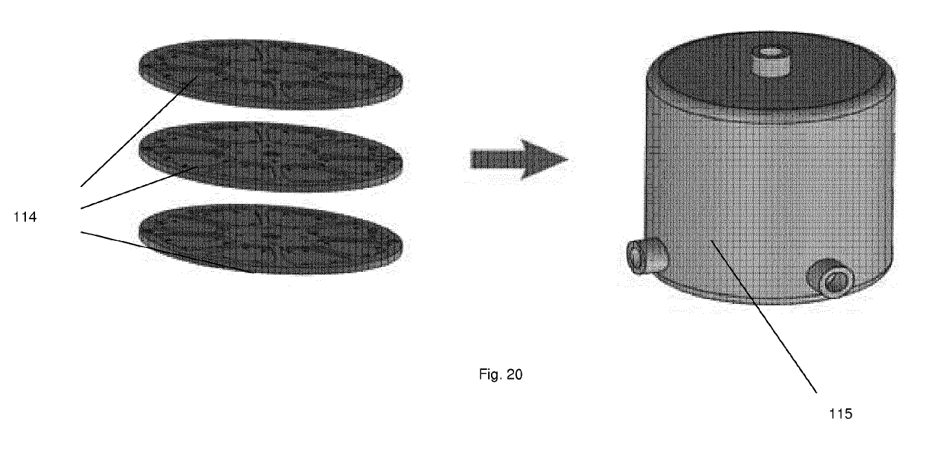

FIG. 20 shows, schematically, on the left hand side, three supports for holding plates as described herein in a circular configuration (although the plates are not shown for clarity), and, on the right hand side, a housing for the supports and plates. In this embodiment, the support is such that plates are arranged in parallel, in contrast to the arrangement in FIG. 9, in which the plates are arranged in series. In other words, in the parallel arrangement, all plates on a support receive the same source of fluid, and separate it into different portions at the same time (one of the portions having large particles, i.e. the portions from the outlet of the first channels of the plates, the other of the portions having smaller particles, i.e. from the outlet of the second channel of the plates). This parallel arrangement of plates allows a large volume of fluid to be processed by the system.

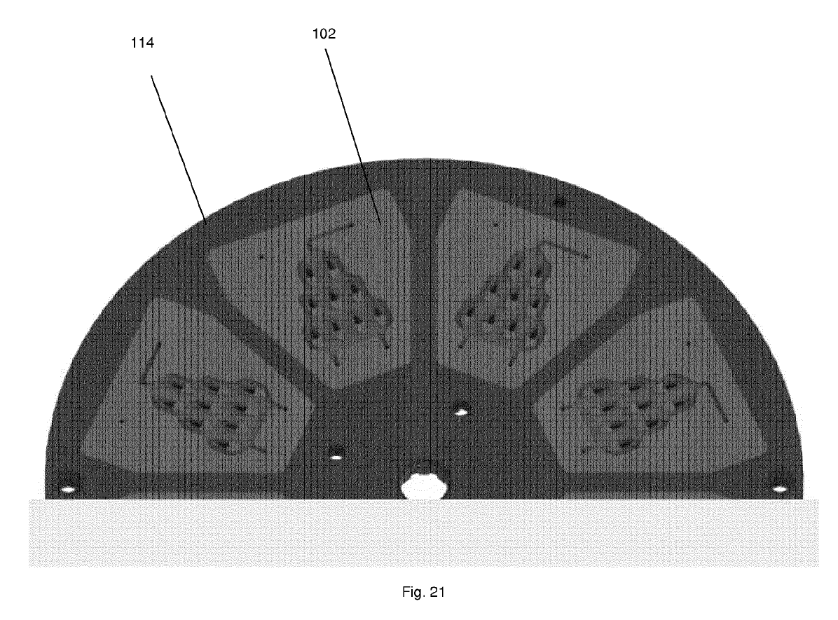

FIG. 21 is a closer view of a support of FIG. 20, but in this Figure the plates are shown in place on the support, viewed from above the first side of the plates.

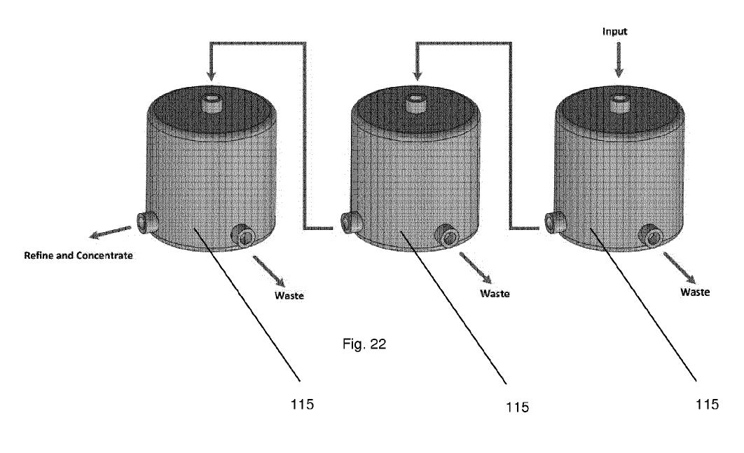

FIG. 22 shows, schematically, a plurality of the separation systems of FIG. 20 arranged in series. In this Figure, input fluid flows into the housing on the right-hand side, and passes through the plates therein, which are arranged in parallel. The fluid exiting the first channels of the plates (i.e. not having passed through to the second channels of the plates) exits the housing where shown (labelled ‘waste’); this contains relatively large particles that were not able to pass between the pillars on the first side of the plates. The fluid that passes through to the second side of the plate, i.e. between the pillars on the first side and through the apertures in the plate, then passes to the next housing (i.e. the middle housing in the Figure), and is passed into the first channel of further plates (these plates having a smaller gap between the pillars on the first side of the plates than those in the right-hand housing). Fluid that passes out of the outlet of the first channels in the plates (i.e. containing particles that were not able to pass between the pillars) then exits the housing (again denoted ‘waste’ in the figure). Fluid that passes through to the second side of the plate (containing particles that pass between the pillars) is then passed to the left-hand housing, which again contains further plates, which have a smaller gap between pillars on the first side of the plate than those in the middle housing. Fluid that passes out of the outlet of the first channel (not having passed through the apertures to the second channel) exits the housing (again denoted waste), and fluid that passes through to the second channels exits the housing at another outlet (denoted ‘refine and concentrate’), and this has had undesired large particles removed. This may be used, for example, to purify water containing undesirable particulates, which may include living species such as bacteria and viruses, as well as non-living particulates. The ‘refine and concentrate’ sample exiting the system has had larger undesirable particulates removed. In some circumstances, however, the fractions (or samples) containing the larger particles may, in themselves by useful and be collected and used for another purpose.

### EXAMPLES

A device for the continuous refining of particles was made in accordance with the design shown in FIGS. 13A and 13B. FIG. 13A shows a view of the side of the plate having the first channel therein. FIG. 13B shows a view of the side of the plate having the second channel therein. The design of this plate is very similar to that shown in FIGS. 1A and 1B, except that it contains fewer apertures (i.e. 9 apertures) between the first channel and the second channel. It also has an outlet for the second channel that is diverted to the first side of the plate and then back to the second side of the plate, such that a round aperture is used to connect the plate to the pipe (or, in other embodiments, an O-ring, when on a support in sequence configuration); this has been found to reduce any clogging that may occur in the outlet for the second channel, owing to an O-ring or similar pressing on the channel. Moulds for producing the plates were first produced similar to those as illustrated in FIGS. 10 and 11 and discussed above (but again having negative features to produce the 9 apertures between the first and second channels and the surrounding macro- and micropillars). Each mould was machined from a high-alloy hot-work steel from Meusburger quality 1.2344 ESR. This is a very hard steel quality highly suitable for mirror polishing. Using these moulds, plates were produced as shown in FIGS. 13A and 13B, by injection-moulding a plastic into the mould. The plastic used was a Cyclic Olefin Copolymer (COC), commercially available from TOPAS® (TOPAS® 5013L-10 Injection moulding grade for optical applications). In the plate, adjacent pillars on the first side had a spacing of 180 μm (i.e. this was the spacing between adjacent smaller pillars (the micropillars) and also the spacing between each macropillar and the nearest micropillar). 50 plates were produced, although only a small number were used for the test below. No problems were observed in the production process. Cover sheets were adhered to each side of the plate to cover the first and second channels, in a similar manner as shown in FIGS. 1A and 1B (with the plate covering the second channel having suitable apertures therein to correspond with the inlets and outlets, in the same manner as shown in FIGS. 1A and 1B). The cover sheets were Platemax, UltraClear Sealing Film, Axygen Inc., Union City, Calif. 94587, USA. This was a transparent film having a silicone adhesive on one side, which is adhered to the plate. Tubes were connected and adhered to the inlets and outlets of the plate using Loctite® superglue.

The above-described device was tested for its ability to separate and concentrate plastic beads. The plastic beads were a mixture of beads having diameters of 212-250 μm and 63-75 μm. More, specifically, the beads of 212-250 um diameter were Violet Polyethylene Microspheres, Density: ˜1 g/cc, and the beads of 63-75 μm diameter were Fluorescent Yellow Polyethylene Microspheres, Density: ˜1.02 g/cc. These beads were mixed in a beaker glass with water containing 2 wt % of Bio Compatible Surfactant from Cospheric LLC in Santa Barbara, USA, to form a suspension of the beads. Before testing, the suspension rested for 24 hours to reduce any problems with static electricity.

A plastic syringe (10 ml or 20 ml, Luer-Lok™ Syringe, BD Drogheda, Ireland) was filled with suspension containing plastic beads. An Aladdin AL-1000 syringe pump (World Precision Instruments, Inc., FL, USA) was used to control flow rate and volume. In some of the tests the syringe pressure was altered manually being able to vary the pressure fast. Concentrate and permeate fractions (i.e. the fractions from the two outlets, one from the outlet from the first channel, and one from the outlet of the second channel) were collected in plastic bowls for later microscope inspection. A Nikon Stereo Microscope with a photo tubes connected to a Nikon camera able to film the process in HD Quality.

Analysis of the concentrate (i.e. the sample having passed out of the outlet of the first channel and containing larger beads than the permeate) and permeate (i.e. the sample having passed through the apertures in the plate from the first channel to the second channel and then through the outlet of the second channel), showed a successful separation of the larger beads (i.e. those having a 212-250 μm diameter) from the smaller beads (i.e. those having a 63-75 μm diameter). The device was able to sort beads in a very efficient way.

Plates could be combined as described herein for sequential concentration and separation of various fractions of particles.

It was also found in other tests that a surface coating of polyethylene glycol on the surface of the first and/or second channels and/or on the micro- and micro-pillars improved the efficiency of the device. The efficiency of the separation was also found to increase when the number of apertures was increased. Additionally, using inlets, outlets and channels of larger than 1 mm was found to reduce any tendency for clogging. Where clogging was seen to occasionally occur, varying the flow rate was found to reduce the tendency for clogging.

1. A device for the continuous refining of particles of differing properties, the device comprising:
a combination of upstream and downstream separation and concentration systems, each of the upstream and downstream separation and concentration systems comprising:
a plate having opposing first and second sides, each of first and second sides having disposed thereon or therein first and second channels, respectively, the first and second channels being fluidly connected to one another by a plurality of apertures through the plate that allow fluid flow from the first to the second channel, and
a plurality of pillars are disposed on the first side of the plate adjacent each aperture to prevent particles above a certain size passing through the aperture, the fluid flow direction along first and second channels during separation being approximately the same,
and the plate has an outlet from the first channel downstream from the plurality of apertures on the first side of the plate,
wherein the upstream separation system has an outlet from the second channel that is fluidly linked to the inlet of the first channel of the downstream separation system, and
the separation distance between adjacent pillars on the first side of the plate in the upstream system is more than the separation distance between adjacent pillars on the first side of the plate in the downstream system.

2. The device according to claim 1, wherein the first and second channels in one of, or each of, the upstream and downstream separation systems are formed in the first and second sides, respectively, of the plate and the plurality of pillars on the first side of the plate are integrally formed with the plate.

3. The device according to claim 1 or claim 2, wherein, around each aperture, the plurality of pillar disposed on the first side of the plate comprises a macropillar and a plurality of micropillars, the macropillar being disposed adjacent the aperture and substantially upstream from the aperture when fluid flows from the inlet of the first channel to the outlet of the first channel, the micropillars being adjacent the aperture and located substantially downstream from the macropillar.

4. The device according to claim 3, wherein the macropillar has a diameter, measured in a direction perpendicular to the flow from the inlet to the outlet of the first channel, that is the same as or larger than, the diameter of the aperture to which it is adjacent, measured in the same direction.

5. The device according to claim 3 or 4, wherein the macropillar has a cross-sectional shape that tapers in a direction opposite the flow from the inlet to the outlet of the first channel.

6. The device according to any one of claims 3 to 5, wherein at least five micropillars are disposed adjacent the aperture.

7. The device according to any one of claims 2 to 6, wherein the macropillars and micropillars have a cross sectional shape selected from an n-sided polygon, optionally having rounded corners and/or sides, circular, oval and ovaloid.

8. The device according to any one of the preceding claims, wherein a plurality of pillars are disposed on the second side of the plate and extend into the second channel.

9. The device according to claim 8, wherein each of the plurality of pillars disposed on the second side of the plate have a cross-section shape that is elongated along the direction of flow toward the outlet of the second channel.

10. The device according to claim 8 or claim 9, wherein each of the plurality of pillars disposed on the second side of the plate is located between two apertures (in a direction perpendicular of the flow along the second channel toward the exit of the second channel).

11. The device according to any one of the preceding claims, wherein the first and/or second channel(s) taper(s) in a direction toward each of its/their outlet(s), the channel(s) tapering along substantially the whole of its/their length that is occupied by apertures.

12. The device according to claim 11, wherein the first and second channels are each covered by a cover layer adhered to the plate to seal the channels.

13. The device according to any one of the preceding claims, wherein the cover layer is adhered to the ends of the pillars disposed on the first side of the plate and, if present, the ends of the pillars disposed on the second side of the plate.

14. The device according to any one of the preceding claims, wherein the device further comprises a mixer for homogenising a fluid, the mixer being fluidly connected to the first and/or second channels of the upstream or downstream separation and concentration system.

15. The device according to any one of the preceding claims, wherein the device comprises a support, and the plates of the upstream and downstream separation and concentration systems are removable from the support, the support having conduits therein, for transferring fluid from the outlet of the second channel of the upstream separation and concentration system to the inlet of the first channel of the downstream separation and concentration system.

16. The device according to any one of the preceding claims, wherein the support further comprises a conduit for passing fluid to the inlet of first channel of the upstream separation and concentration system and a conduit for removing fluid from the outlets of the first and/or second channels of the upstream and/or downstream separation and concentration system.

17. The device according to any one of the preceding claims, wherein the distance between two adjacent pillars adjacent an aperture on the first side of the plate of the upstream separation and concentration system is 1 mm or less.

18. The device according to any one of the preceding claims, wherein the distance between two adjacent pillars adjacent an aperture on the first side of the plate of the upstream separation and concentration system is 50 μm or less.

19. The device according to any one of the preceding claims, wherein the distance between two adjacent pillars adjacent an aperture on the first side of the plate of the upstream separation and concentration system is 1 μm or less.

20. A method for the continuous separation and concentration of particles of differing properties, the method comprising:
providing a device according to any one of claims 1 to 19,
inputting a fluid comprising a mixture of particles of varying properties into the first channel of the upstream separation system, such that the fluid flows along the first channel to the plurality of apertures, with some of the fluid (a first portion) passing along the outlet of the first channel,
and some of the fluid (a second portion) passing through the apertures into the second channel and through the output of the second channel of the upstream separation system to the input of the first channel of the downstream separation system,
the second portion of the fluid passing along the first channel of the downstream separation system to the plurality of apertures, with some of the fluid (a third portion) passing along the outlet of the first channel and some of the fluid (a fourth portion) passing through the apertures into the second channel and through the output of the second channel of the downstream separation system,
wherein the first portion of fluid has a higher concentration of larger particles than the fourth portion of fluid.

21. A separation and concentration system comprising:
a plate having opposing first and second sides, each of first and second sides having formed therein first and second channels, respectively, the first and second channels being fluidly connected to one another by a plurality of apertures through the plate that allow fluid flow from the first to the second channel, and
a plurality of pillars are disposed on the first side of the plate, the pillars being integrally formed with the plate, wherein the pillars are disposed adjacent the apertures to prevent particles above a certain size passing through the apertures, the fluid flow direction along first and second channels during separation and concentration being approximately the same.

22. A method for forming a separation and concentration system, the method comprising: forming a plate as defined in claim 21 from a single material.

23. A method according to claim 22, wherein the plate is formed by injection moulding a plastic.

24. A method according to claim 22 or claim 23, wherein the plate is formed by injection moulding a plastic into a mould, the mould having projections for forming the first and second channels in the plate and apertures through the plate, and recesses for forming the plurality of pillars on the first side of the plate.
